(19) United States
(12) Patent Application Publication
(10) Pub. No.: US 2005/0094271 A1
(43) Pub. Date: May 5, 2005

(54) Hybrid optical component for x ray applications and method associated therewith

(75) Inventor: Peter Hoghoj, Saint Martin Le Vinoux (FR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Xenocs, Sassenage (FR)

(21) Appl. No.: 10/478,814

(22) PCT Filed: May 31, 2002
(86) PCT No.: PCT/FR02/01831

(30) Foreign Application Priority Data
Jun. 1, 2001 (FR) 0107228
Jul. 20, 2001 (FR) 0109729

(51) Int. Cl. G02B 5/18

(52) U.S. Cl. 359/572; 359/563

(57) ABSTRACT

One aspect of the invention relates to a multi-layered reflective optical system for the reflection of X rays at a low angle of incidence, producing a two-dimensional optical effect. The inventive optical system comprises: a component having a surface which is reflective in such a way that a first optical effect is produced according to a first direction in space; and means for producing a second optical effect according to a second direction in space which is different from the first direction, characterized in that said means for producing a second optical effect are borne by the reflective surface. A second aspect of the invention relates to a method for the production of said optical system.

The present invention relates in general to multilayer reflective optical assemblies for reflecting X-rays at a low angle of incidence.

The term “low angle of incidence” is to be understood to mean angles of incidence of less than a value of around 10° (the angle of incidence being defined with respect to the reflecting surface).

More precisely, the invention relates to a multilayer reflective optical assembly for reflecting X-rays at a low angle of incidence, producing a two-dimensional optical effect, the optical assembly comprising:
a component having a reflecting surface shaped so as to produce a first optical effect in a first direction in space; and
means for producing a second optical effect in a second direction in space, different from the first direction.

According to one particular aspect, the invention also relates to a process for producing such an optical assembly.

The expression “two-dimensional optical effect” is understood to mean an optical effect using two different directions in space.

This may, for example, be the focusing or the collimation of a beam whose rays are not parallel in any direction in space (for example, a divergent conical beam).

Non-limiting applications of the invention relate to the generation of X-rays, to analytical applications of X-rays, such as diffraction, diffraction of crystals, crystalography of proteins, analysis of textures, diffraction of thin films, stress measurement, reflectometry, X-ray fluorescence.

Optical assemblies of the abovementioned type are already known.

Considering for example X-ray generation installations, an example of this application will be found in document JP 10-073698(NTT).

This document discloses an X-ray generation installation in which an optical assembly is formed by two components, each providing a respective optical effect in two different respective directions.

A first component of this optical assembly is a mirror 4 whose parabolic surface allows X-rays to be concentrated onto an output slit 5 of the device.

This corresponds to a first optical effect, provided by the shape of the mirror 4.

A second optical component of this optical assembly is a plane diffractive structure 3 located upstream of the mirror 4.

This second component allows the X-rays generated by impact on a target 1 to be diffracted, this corresponding to a second optical effect.

The optical assembly, formed from the structure 3 and the mirror 4, thus makes it possible to combine two optical effects that are produced in two different directions.

This results in a two-dimensional optical effect, in this case the focusing onto a point of a volume beam emanating from the target 1).

However, a drawback associated with such an optical assembly arises from the fact that the two optical effects are associated individually with two separate components, and that it is necessary to position one with respect to the other in an extremely precise manner.

The optical assembly must therefore be set with very great precision during its installation. This corresponds to a complex and time-consuming operation.

Furthermore, the respective positions of these two components are liable to vary over time, which would have the effect of degrading the performance of the optical assembly.

An alternative solution for obtaining a two-dimensional optical effect would be to form an optical assembly comprising only one component in the form of a non-cylindrical mirror (the surface of which would be shaped according to a complex geometry, for example a paraboloid or an ellipsoid).

However, such mirrors of complex shape are expensive and difficult to produce.

Furthermore, another drawback associated with the optical assemblies of the type of that in document JP 10-073698 is that the X-rays must be reflected from two different surfaces (the respective surfaces of the two components) in order for the two optical effects to be exerted on them.

This results in attenuation of the rays passing through the optical assembly.

Furthermore, such an optical assembly must necessarily have quite a large longitudinal dimension in the general direction of propagation of the rays in order to allow the rays to be reflected by the two components, one after the other.

Furthermore, certain rays may be reflected only by one of the two components, and thus correspond to spurious rays. The removal of these spurious rays requires the use of complementary means that further complexity such an optical assembly.

A first object of the invention is to produce multilayer reflective optical assemblies of the type mentioned at the very beginning of this text, without being subject to the abovementioned drawbacks.

A second object of the invention is to also allow various optical characteristics of such a reflective assembly to be adjusted extremely precisely, this adjustment of the characteristics being permanent and irreversible. The characteristics to be adjusted may in particular comprise the phase-shift and reflectivity characteristics of the optical assembly.

It will be recalled that the expression “phase-shift characteristics” means the property that consists in phase-shifting, to a greater or lesser extent, the radiation reflected by a reflective structure.

Alteration of the reflectivity and/or alteration of the phase shift are also optical effects, which may be exerted in a given direction.

To achieve the various abovementioned objects, the invention proposes, according to a first aspect, a multilayer reflective optical assembly for reflecting X-rays at a lower angle of incidence, producing a two-dimensional optical effect, the optical assembly comprising:
a component having a reflecting surface shaped so as to produce a first optical effect in a first direction in space; and
means for producing a second optical effect in a second direction in space, different from the first direction; characterized in that said means for producing a second optical effect are carried by said reflecting surface.

Preferred, but non-limiting, aspects of the optical assembly according to the invention are the following:
the reflecting surface is shaped according to one of the following geometries:
   cylindrical, with a cylinder possibly having, for example, a:
      circular directrix or
      parabolic directrix or
      elliptical directrix,
   spherical;
the multilayer has a lateral gradient;
said means for producing a second optical effect comprise a diffractive pattern;
the reflecting surface is a cylinder and the diffractive pattern comprises diffraction lines made perpendicular to the axis of this cylinder;
said diffractive pattern is produced in relief on the multilayer, or etched into the structure of the multilayer;
said means for producing a second optical effect comprise a refractive pattern;
said refractive pattern is a pattern of the Kino lens type;
said refractive pattern is produced in relief on the multilayer or etched into the structure of the multilayer;
said first one-dimensional optical effect and said second one-dimensional optical effect are each:
   a collimation in two respective directions or
   a focusing in two respective directions.

According to a second aspect, the invention also proposes a process for manufacturing such an optical assembly.

Preferred, but non-limiting, aspects of the process according to the invention are the following:
the process is carried out according to the sequence of the following main steps:
   that of depositing a multilayer on a planar substrate, then of shaping this multilayer so as to give it the desired geometry for the reflecting surface and, finally, of forming a pattern on the curved multilayer mirror thus created,
   that of depositing the multilayer on a planar substrate, of creating the pattern on top and then of shaping the combination to the desired geometry,
   that of generating a shaped surface with the desired geometry, then of depositing a multilayer on top and of forming a pattern on the combination,
   that of generating a shaped surface with the desired geometry, then of forming a pattern on top and of depositing a multilayer on the combination and
   that of generating the pattern first, directly on an initial planar substrate, and then of carrying out, in either order, the shaping of the surface and the deposition of a multilayer;
the pattern comprises a diffractive pattern and the process comprises the creation of a diffractive structure by changing a multilayer structure following the exposure of the structure to an energy beam (20), the process comprising the control of the exposure of the desired regions of the multilayer structure to said beam, so as to shift the value of the reflectivity peak (Λ1) of each region of the structure in the desired manner within the wavelength spectrum;
said exposure control is performed by adapting the duration of exposure of each individual region of the structure to the beam;
said exposure control involves a temporary and controlled modification of the energy of the beam; and
the pattern comprises a refractive pattern and the process comprises the etching of a resist or of a light element in order to create the refractive pattern.

Other aspects, objects and advantages of the invention will become more clearly apparent on reading the following description of an embodiment of the invention, given with reference to the appended drawings in which:

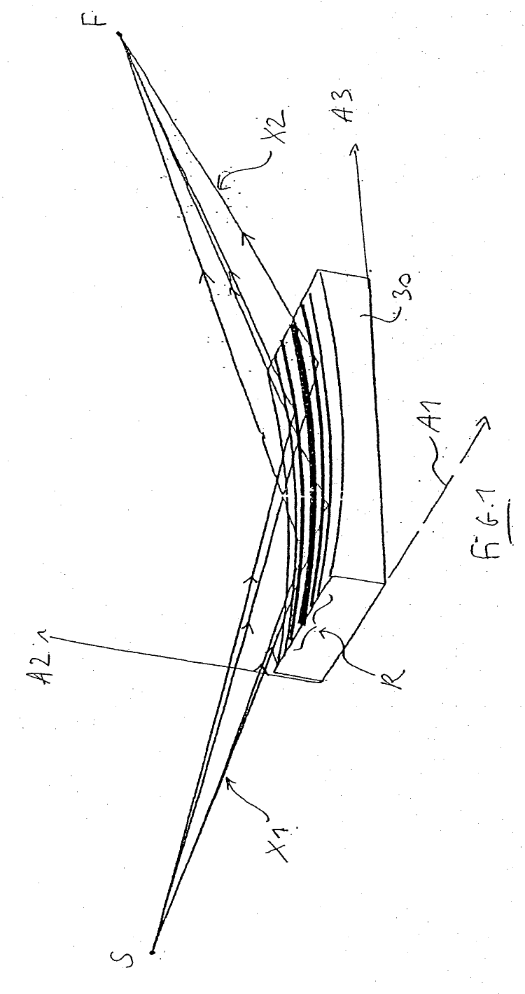

FIG. 1 shows schematically a multilayer mirror that corresponds to a first main embodiment of an optical assembly according to the invention;

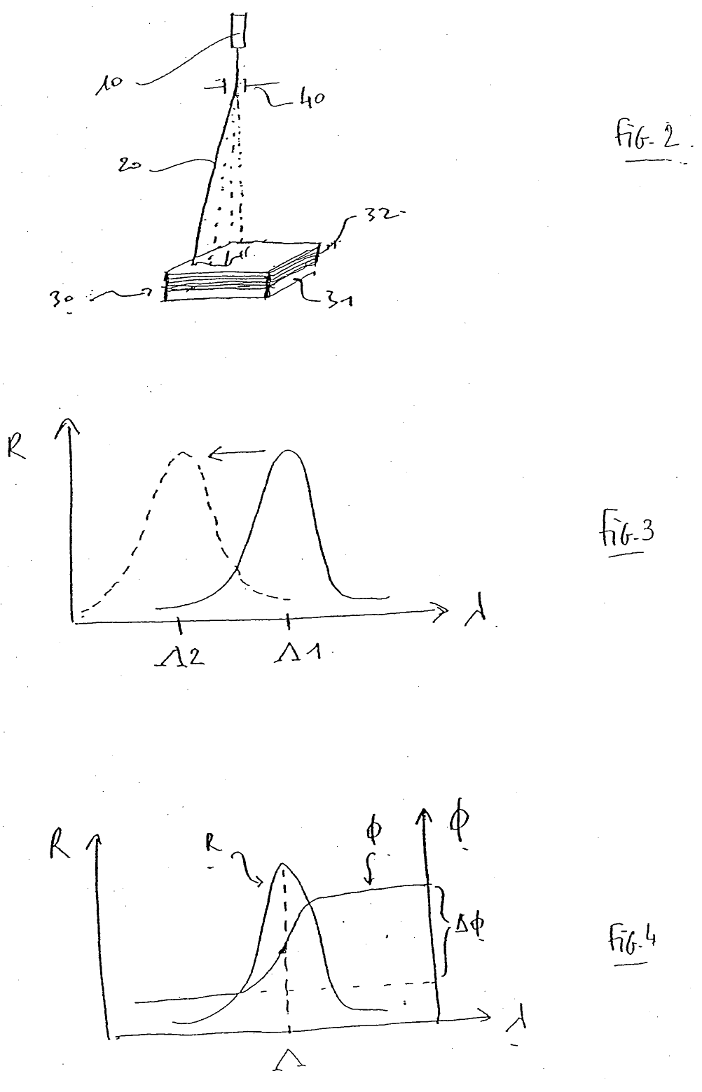

FIG. 2 is a schematic representation of an installation for producing optical assemblies according to the invention, according to a preferred embodiment;

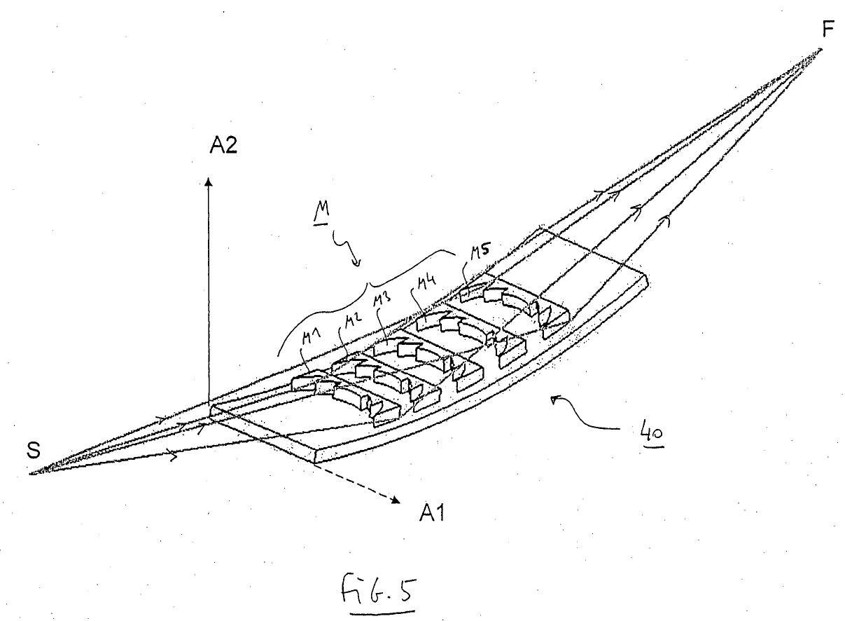

FIGS. 3 and 4 are graphs indicating certain information relating to the preferred embodiment corresponding to the installation of FIG. 2, FIG. 3 being a graph showing the change in the position of the reflectivity peak of a multilayer structure after having been subjected to an energy beam and FIG. 4 being a graph showing the reflectivity characteristic of a multilayer reflective structure and the phase characteristic of the radiation reflected by such a structure; and

FIG. 5 shows schematically a multilayer mirror that corresponds to a second main embodiment of an optical assembly according to the invention.

FIG. 1 shows a curved multilayer X-ray mirror 30 constituting an optical assembly according to the invention.

This mirror is intended to reflect X-rays at a low angle of incidence, just like all the optical assemblies to which the present text pertains.

This mirror, like the mirrors of the optical assemblies to which the present text pertains, is furthermore a multilayer whose layer structure is adapted so that the Bragg condition is respected at every point on the useful surface of the mirror.

In this text, such mirrors will be called by convention “laterally-graded” mirrors.

It should also be pointed out that the multilayer of the various embodiments of the invention may also be depth-graded.

It will be recalled that the Bragg condition is of the form nλ=2dsinθ, where:
n: order of the reflection;
λ: wavelength of the incident radiation;
d: period of the multilayer;
θ: angle of incidence of the surface of the multilayer.

Thus, for X-ray incidents within a narrow wavelength band such as, for example, the copper Kα line (centered around a wavelength of 0.15405 nanometers), the laterally-graded multilayer mirror allows the Bragg conditions to be maintained over the entire useful surface of the mirror.

This results in the reflection of the predetermined wavelength band (in the example above the copper Kα line) by various regions of the mirror on which the incident rays have variable local angles of incidence.

It is thus possible to increase the area of the mirror that is actually used.

The gradient is obtained by locally varying, in a suitable manner, the period of the multilayer.

As is well known, this type of graded multilayer structure makes it possible to increase the collection solid angle of the optic, which results in a higher reflected flux than for monolayer mirrors operating in total reflection, for the same optical geometry.

The surface of the mirror 30 is curved, the thickness of the multilayer varying.

This multilayer mirror has a substrate as support.

The direction A1 is fixed in the example of FIG. 1.

As for the direction A3, this varies depending on the point on the surface of the mirror in question, and it is represented only for one of these points: this is the direction that defines, with the direction A1, the local tangent plane to the general geometry of the surface of the mirror.

This surface of the mirror defines a cylindrical portion, the axis of the cylinder being parallel to a direction shown in FIG. 1 by the axis A1.

Thus, the mirror focuses the incident X-rays (denoted by X1) emanating from a source S, in a direction A2 perpendicular to the directions of the axis A1 and of the axis A3.

The direction A2 therefore also changes according to the point on the surface of the mirror in question; this is the local direction normal to the surface of the mirror (the direction normal to the local tangent plane).

The mirror 30 has also been treated in order to form, on its reflecting surface, a grating of regions R that remain reflecting as regards the incident X-rays but cause a phase shift of their reflected radiation X2.

We shall return later in this text to one particular embodiment of the invention allowing such regions R to be formed.

These regions each have the shape of an elongate strip, all the regions extending parallel to the general direction A3, which is perpendicular to the direction A1.

The phase changes generated by these regions R cause interference patterns, which correspond to a diffraction phenomenon.

Furthermore, this diffraction causes a second focusing of the rays X1—this second focusing taking place in the direction A1—in such a way that the reflected rays X2 are focused in two perpendicular directions onto a desired point.

The mirror 30 thus causes a two-dimensional optical effect, namely first focusing in the direction A2, due to the general geometry of the surface of the mirror, and second focusing in the direction A1, due to the diffraction generated by the regions R.

This mirror 30 thus constitutes one embodiment of the invention, which allows the rays emanating from the source S to be focused onto a focal point F.

It should be pointed out that, compared with optical assemblies comprising various components each dedicated to an optical effect, the invention allows the drawbacks mentioned in the introduction of the present text to be overcome.

In particular, no setting or adjustment of the position of various components is necessary, the mirror 30 comprising only a single component that provides two optical effects (in this case, twofold focusing, namely focusing in two different directions).

It is thus possible to form an optical assembly in the form of a multilayer mirror whose reflecting surface is shaped so as to provide a first optical effect in a first direction in the space (focusing or collimation effect in one direction, for example) with means carried by the same surface in order to provide a second optical effect in a second direction in space, different from the first direction.

These means may, in a first main embodiment of the invention, be a diffractive structure that may have a desired diffractive pattern.

As will be seen, these means may, in a second main embodiment of the invention, be a refractive structure that may have a desired refractive pattern.

Returning to the first main embodiment of the invention, such a diffractive structure may be a structure operating in amplitude space and/or in phase space.

Such a diffractive structure may be generated on the surface of the mirror of the optical assembly by a lithography technique.

We shall return later in this text to an example of a process allowing such structures to be created.

The surface of the mirror has a shape that is intended to generate a one-dimensional optical effect in a first direction in space.

This optical effect may in particular be a one-directional focusing or a one-directional collimation in a first direction in space.

Likewise, the second optical effect generated by the means carried by the surface of the mirror may correspond to a one-directional focusing or a one-directional collimation in a second direction in space different from the first direction.

The two optical effects thus combine to produce a two-dimensional optical effect, such as a two-dimensional focusing onto an image point (combination of two one-dimensional focusing effects) or a collimation of a divergent incident beam into a parallel beam in any direction in space.

The shape of the mirror has a simple geometry that is easy and inexpensive to produce.

This shape may in particular be produced in one of the following geometries:
cylindrical, with a cylinder possibly having, for example, a:
   circular directrix or
   parabolic directrix or
   elliptical directrix,
spherical.

In the case of a cylindrical mirror, the lines of the diffractive structure may be produced on the shaped surface of the mirror perpendicular to the axis of the cylinder (as illustrated in FIG. 1).

Another advantage of the invention is that the X-rays undergo only a single reflection on the optical assembly. Consequently, the drawbacks mentioned in the introduction as regards the known configurations having two reflective surfaces are eliminated.

Regarding now the manufacture of an optical assembly according to the invention, several methods of forming such an assembly may be envisioned.

In particular, it is possible for the process to be carried out according to one of the following general methods:
a multilayer is deposited on a planar substrate, this multilayer is then shaped so as to give it the desired geometry for the reflecting surface and, finally, a pattern (a diffractive pattern or refractive pattern—these means will be denoted by the general term “pattern”) is formed on the curved multilayer mirror thus created. In this case (as in the other cases), it will be possible to adjust the thickness of the multilayer after it has been shaped to the desired geometry and to produce the period gradients that are needed to satisfy the Bragg condition;
the multilayer is deposited on a planar substrate, the pattern is created on top and then the combination is shaped to the desired geometry;
a surface shaped to the desired geometry is generated, then a multilayer is deposited on top and a pattern is formed on the combination;
a surface shaped to the desired geometry is generated, then a pattern is formed on top and a multilayer is deposited on the combination; and
it is even possible to generate the pattern first, directly on an initial planar substrate (for example by etching the substrate), then to carry out, in either order, the shaping of the surface and the deposition of a multilayer.

Regarding more particularly the formation of a diffractive pattern which corresponds to a first main embodiment of the invention, one particular technique will now be described for manufacturing such a pattern that allows various characteristics of the optical assembly (in particular, the phase and amplitude behavior) to be simultaneously adjusted.

FIG. 2 shows schematically an installation for implementing this preferred embodiment.

This installation is designed to create a diffractive structure in a desired pattern on a multilayer.

It should be pointed out that in the present text the reference 30 will refer, indiscriminately, to a multilayer at its various stages of production (multilayer alone, finished multilayer corresponding to the optical assembly according to the invention, for example assembly 30 in FIG. 1).

This installation includes a source 10 capable of emitting an energy beam 20.

The energy beam 20 may be a particle beam. In this case, particles of the beam may, for example, be ions, but also electrons, molecules, etc.

The beam 20 may also be a beam of pure radiation, for example a photon beam, an X-ray beam, etc.

The source 10 may thus be of a type known per se, for example an electron source similar to those employed for etching the photoresist of lithography masks.

In all cases, the beam 20 is a beam capable of altering the structure of the multilayer 30, which is exposed to the beam 20, and of modifying the thickness of the layers of this multilayer by its influx of energy.

It should be pointed out that the influx of energy from the beam to the multilayer may come directly from the energy of the beam, in the case of an energy beam.

It is also possible for this energy applied to the multilayer to come from a reaction induced by the beam 20 encountering the multilayer 30.

Such a reaction may, for example, be a chemical reaction (in the case of a beam of oxygen particles that oxidize the multilayer) or a nuclear-type reaction.

The multilayer 30 comprises a substrate 31 and a stack 32 of alternating layers.

The stack 32 comprises an alternation of layers (for example Mo and Si layers) whose reflectivity optical properties make it possible for the radiation of a given wavelength from a source (not shown in the figure) to be reflected.

The specific reflectivity properties of the multilayer stack 32 determine a wavelength range for which the radiation will be effectively reflected.

It will therefore be understood that a given multilayer structure can reflect radiation within a given wavelength range.

More precisely, when exposed to incident radiation of a given amplitude and given wavelength, a reflective multilayer structure produces reflected radiation whose amplitude varies as a function of the wavelength of the incident radiation.

This principle exploited in the invention is illustrated in the graph in FIG. 3.

This graph shows the variation, for a multilayer reflective structure, of the reflectivity coefficient R (which is determined by the proportion of light energy sent back by the reflected radiation) as a function of the wavelength λ of the incident radiation.

It has been found that there is a wavelength Λ1 for which the reflectivity of the structure is a maximum, and that this wavelength Λ corresponds to a well-defined reflectivity peak.

Thus, each reflective structure is associated with a reflectivity peak that is determined by a given wavelength: the structure is better at reflecting radiation whose wavelength is equal, or very close, to this wavelength Λ1 (which is represented by a “period” parameter, Λ1 being equal, or closely tied, to the period).

It should be pointed out that the reflectivity properties of the structure 30 are themselves determined, on the one hand, by the nature of the materials employed in the stack 32 and, on the other hand, by the thickness of the layers of this stack.

Controlled beam-directing means 40 allow said beam to be directed toward desired regions of the structure 30 and allow the beam to be moved over the structure in a predetermined pattern.

In this way, desired regions of the structure are altered as a result of the interaction between the energy beam 20 and the layers of the stack 32.

It should be pointed out that the multilayer structure is not destroyed by this technique.

This is because the structure 30 is exposed in a controlled manner so that the region of the structure exposed to the beam 20 is not destroyed, but the thickness of the layers of the stack are simply modified so as to change the period of this stack in the desired manner.

The reflectivity peak of the exposed region of the structure can thus be shifted in a controlled manner within the wavelength spectrum.

The Applicant has in fact observed that limited and controlled exposure of a multilayer structure, as described above, results in such a shift of the reflectivity peak of said region.

In other words, the reflectivity is not eliminated, rather it is shifted within the wavelength spectrum.

This does not make regions that are “absorbent” in the absolute, rather it makes them absorbent for a given wavelength range, the reflectivity properties of these regions remaining for other wavelengths.

This principle is explained in the graph of FIG. 3, which shows the reflectivity peak at Λ1 of a region of the structure before its exposure to the beam 20 and the reflectivity peak at Λ2, corresponding to the same region after its exposure to said beam.

The reflective properties of the regions of the structure 30 that are exposed in a controlled manner to the beam 20 are thus altered in a desired (and permanent) manner in such a way that these regions are, after exposure, still capable of reflecting radiation with an intensity comparable to reflected radiation intensity, but only insofar as the incident radiation has a wavelength that corresponds to the new reflectivity peak of the region treated.

Furthermore, this shift of the reflectivity peak is itself controlled insofar as the exposure is adapted so as to bring the reflectivity peak of the exposed region to a desired value, different from the value of the reflectivity peak of the regions of the structure that were not exposed to the beam 20.

Exposure control may be accomplished by adapting the period of exposure of each individual region of the structure to the beam 20.

Exposure control may also involve a temporary and controlled modification of the energy of the beam 20.

Thus, it is possible to treat any desired region of the structure 30, so as to shift the reflectivity peak of the region in a controlled manner.

Starting from a structure such as a multilayer mirror, whose multilayer structure allows X-rays to be reflected, it is thus possible according to the invention to treat certain regions of the mirror so that their reflectivity peak is shifted in such a way that said regions do not reflect X-rays.

Thus, a mask reflective to X-rays is formed.

It should be understood that it is thus possible to treat desired regions of a reflecting structure according to the wavelength of the radiation source with which the structure is intended to cooperate once it has been treated.

Specific regions of this structure will therefore be treated to make them nonreflecting with respect to the specific radiation of this source (in this case an X-ray source).

Thus, it is possible to treat a structure “negatively”, by treating certain regions so as to shift their reflectivity peak for the purpose of making them nonreflecting in respect of a radiation source of given wavelength, whereas the untreated regions of the structure intrinsically have a reflectivity peak corresponding to the wavelength of this source and will therefore reflect its radiation.

It is also possible to treat regions of the structure “positively”, by shifting their reflectivity peak so that, on the contrary, it corresponds to the wavelength of a radiation source and so that the treated regions are therefore rendered reflective in respect of this source, although the structure initially had a period that did not correspond to the wavelength of the source so that it did not reflect its radiation.

According to an advantageous variant, it is possible to define, on the surface of the structure to be treated, regions that it is desired to treat differently, not only by making them selectively reflective or nonreflective in respect of a given wavelength (and therefore again in this case an X-ray source), but also by degrading the reflectivity properties for a given wavelength of these regions in a controlled manner.

It is thus possible to form, on the structure, regions of greater or lesser reflected light response to radiation of a given wavelength by subtly defining the change of period (and therefore the shift of the reflectivity peak) of each region.

It is thus possible to form structures whose response in reflection to radiation of a given wavelength is of the “analogue” type, the various regions having reflectivity peaks shifted differently so as to remain reflective in respect of the source radiation, but with different reflectivity coefficients—in this way, a structure whose various regions reflect as different “gray levels” is constructed.

It is also possible according to the invention to control the spatial distribution of the radiation reflected by the various regions of the structure 30.

The radiation reflected by a region of the structure may in fact be described by the formula A.e^{i(Kλ+θ)}.

As illustrated in FIG. 4, the period A associated with a region of the multilayer structure defines not only a reflectivity maximum but also a region of change of the phase Φ of this reflected radiation.

More precisely, a phase change ΔΦ of around 180 degrees on either side of the wavelength Λ corresponding to the period of the region in question is observed.

By modifying the period of said region in the desired manner by controlled exposure to the beam 20, the phase characteristics of the reflected radiation are therefore also modified.

It is therefore possible to “draw” on the structure 30 regions whose reflected radiation, when exposed to a source of defined wavelength, undergoes a desired phase change.

Such control is particularly beneficial insofar as it makes it possible, using such a structure, to obtain an image of enhanced contrast.

The construction of an optical assembly comprising a multilayer mirror that reflects X-rays, shaped to produce a first optical effect and carrying a diffractive pattern that produces a second optical effect, is not limited to the particular technique that has just been described.

In fact it is possible to create such patterns by any other technique known per se.

Thus, it is possible to produce the diffractive pattern in relief by etching a resist or a layer of a light element or of a light element composite (so that the X-rays are not substantially attenuated on passing through this element), or else to produce the pattern by etching the multilayer (using a lithography technique).

The light elements mentioned above are those of the Periodic Table of the Elements having an atomic number Z of less than 15.

For example, it is possible to use the diffraction effect of a grating of Fresnel zones etched into the multilayer with a geometry that allows them to be used in reflection.

Such structures, called Bragg-Fresnel multilayer lenses, are known and the arrangements of the lenses thus formed will be adapted in order to generate, by the diffractive pattern corresponding to these Bragg-Fresnel multilayer lenses, the desired one-dimensional optical effect (for example, one-dimensional focusing in a single direction in space).

As was mentioned, it is also possible to carry out the invention in a second main embodiment, in which the pattern carried by the surface of the laterally-graded multilayer mirror is a refractive pattern.

In this case, the refraction effect associated with the pattern is combined with the reflection associated with the mirror 40 itself.

The refractive pattern produced may be a pattern of the Kino lens type (as shown in FIG. 5), produced in relief on the multilayer or again etched into the structure of the multilayer.

In the case of a relief structure, the refractive pattern may in particular be created by etching a resist or a light element (such as for example aluminum, beryllium, boron or graphite, in order to reduce the X-ray absorption) that covers the surface of the multilayer.

Such etching may be carried out using lithography techniques.

Thus, it will be beneficial to use planar microelectronic fabrication technologies (lithography and plasma etching) which have the advantage of allowing the geometry of the refractive pattern to be very finely controlled.

However, it should be pointed out that it is also possible to produce the refractive pattern by any other type of technique.

Returning to FIG. 5, this shows a multilayer mirror 40 which, like the mirror 30 of FIG. 1, is a laterally-graded mirror.

The axes A1, A2 and A3 of FIG. 1 are again defined here in the same manner.

The mirror 40 again defines here a cylindrical portion, the axis of the cylinder being parallel to a direction represented by an axis A1.

Thus, the mirror focuses the incident x-rays in the direction A2.

Here again, the general shape of the surface of the mirror may be adapted so as to produce any desired one-dimensional optical effect, as in the case of the mirror 30 of FIG. 1.

The surface of the mirror 40 carries a refractive pattern M.

This pattern M is formed from refractive regions M1 to M5 that produce one-dimensional focusing in a direction parallel to the direction A1.

It should be noted that the diagram shown is simplified insofar that it is possible to have a much larger number of refractive regions so as to obtain short focal lengths able to satisfy the field of application of the invention (for example, focal lengths of less than 1 meter).

For example, it is thus possible to produce a series assembly of several tens of refractive regions having dimensions of a few tens of microns by profitably employing the planar microelectronic technologies mentioned above.

In this second main embodiment of the invention, as in the first, a combination of two one-dimensional optical effects, produced in two different directions in space, is therefore obtained on one and the same optical component in order to generate a two-dimensional optical effect.

Here again, it should be pointed out that the geometry of the surface of the mirror 40 may be adapted in order to generate any one-dimensional effect—in particular a focusing or a collimation effect.

The same applies as regards the refractive pattern M.

Finally, it should be stated that the above-mentioned two main embodiments (diffractive pattern and refractive pattern) may be combined into one optical assembly whose reflective surface shaped to produce a first optical effect carries a pattern that is both diffractive and refractive.

1. A multilayer reflective optical assembly for reflecting X-rays at a low angle of incidence and producing a two-dimensional optical effect, said optical assembly comprising:
a component having a reflecting surface shaped so as to produce a first optical mono-dimensional effect in a first direction in space; and
means for producing a second mono-dimensional optical effect in a second direction in space, different from said first direction, said means for producing said second optical effect being carried by said reflecting surface, said optical assembly enabling production of a two-dimensional optical effect by making said X-rays undergo a single reflection.

2. The optical assembly of claim 1, wherein said reflecting surface is shaped:
as a cylinder with a circular directrix, a cylinder with a parabolic directrix, a cylinder with an elliptical directrix, or a sphere.

3. The optical assembly of either claim 1 or 2, wherein said optical assembly comprises a laterally-graded multilayer.

4. The optical assembly of claim 1, wherein said means for producing said second optical effect comprise a diffractive pattern.

5. The optical assembly of claim 4, wherein said reflecting surface is a cylinder with an axis and said diffractive pattern comprises diffraction gratings made perpendicular to said axis of said cylinder.

6. The optical assembly of claim 4, wherein said diffractive pattern is produced in relief on a multilayer, or etched into a structure of said multilayer.

7. The optical assembly of claim 1, wherein said means for producing said second optical effect comprise a refractive pattern.

8. The optical assembly of claim 7, wherein said refractive pattern is of the Kino lens type.

9. The optical assembly of claim 7, wherein said refractive pattern is produced in relief on a multilayer or etched into a structure of said multilayer.

10. The optical assembly of claim 1, wherein said first mono-dimensional optical effect and said second mono-dimensional optical effect are each a collimation in two respective directions or a focusing in two respective directions.

11. (canceled)

12. (canceled)

13. (canceled)

14. (canceled)

15. (canceled)

16. A process for manufacturing an optical assembly as claimed in claim 1, comprising, in either order on a substrate, the steps of:
generating a shaped surface with a desired geometry, depositing a multilayer and generating a pattern.

17. The process of claim 16 further comprising the steps of:
depositing a multilayer on a planar substrate then shaping this multilayer so as to give it the desired geometry for the reflective surface and, finally, forming a pattern on the curved multilayer mirror thus created.

18. The process of claim 16 further comprising the steps of:
depositing a multilayer on a planar substrate, creating the pattern on top and then shaping the combination to the desired geometry.

19. The process of claim 16 further comprising the steps of:
generating a shaped surface with the desired geometry, then depositing a multilayer on top and forming a pattern on the combination.

20. The process of claim 16 further comprising the steps of:
generating a shaped surface with the desired geometry, then forming a pattern on the top and depositing a multilayer on the combination.

21. The process of claim 16 further comprising the steps of:
generating the pattern first, directly on an initial planar substrate, and then carrying out, in either order, the shaping of the surface and the deposition of a multilayer.

22. The process of claim 16, wherein the pattern comprises a diffractive pattern and the process comprises the creation of a diffractive structure by changing a multilayer structure following the exposure of the structure to an energy beam, the process comprising the control of the exposure of the desired regions of the multilayer structure to said beam, so as to shift the value of the reflective peak of each region of the structure in the desired manner within the wavelength spectrum.

23. The process of claim 22, wherein said exposure control is performed by adapting the duration of exposure of each individual region of the structure to the beam.

24. The process of claim 22, wherein said exposure control involves a temporary and controlled modification of the energy of the beam.

25. The process of claim 16, wherein the pattern comprises a refractive pattern and the process comprising the etching of a resist or of a light element in order to create the refractive pattern.
